(19) United States
(12) Patent Application Publication
(10) Pub. No.: US 2008/0241579 A1
(43) Pub. Date: Oct. 2, 2008

(54) Method for casting a component

(75) Inventor: Christopher A. Kinney, Iuka, MS (US)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 11/731,459

(22) Filed: Mar. 30, 2007

(51) Int. Cl. B32B 15/18; B22D 19/10

(52) U.S. Cl. 428/637; 164/76.1

(57) ABSTRACT

A cast component having localized areas of improved physical properties is disclosed. The component may initially be produced having a void portion in a predetermined area requiring improved physical properties. A second molten material may be added to the void portion such that it chemically bonds to the void portion. The component may then be finished such to a final shape with a localized area of improved physical properties.

### TECHNICAL FIELD

The present invention relates generally to a cast component, and more particularly a cast component having localized areas of improved physical properties.

### BACKGROUND

Cast components are often designed to the limit of their mechanical properties to take advantage of strength to weight ratios. The requirement for more stringent emissions is also a contributing factor due to seeking high combustion pressures and temperatures. Because of the physical characteristics of cast materials, specifically gray cast iron in engine applications, the thermal fatigue limit is often reached causing failure in certain areas of the component. When this happens, it is difficult and time consuming to repair castings and other components often resulting in significant downtime and costs for the component owner. Typically repairs to castings involve removing damaged portions of the casting through machining, and subsequently rebuilding the damaged area by welding.

An example of a component that is susceptible to damage is the cylinder head of an internal combustion engine. Because of repeated heating and cooling of the engine, the cylinder heads often reach their thermal fatigue limit and develop cracks near openings, such as valve seats, fuel injector bores, and exhaust ports. Another problem associated with cylinder heads is warping. When warped, the bottom surface of the head becomes uneven and does not seal properly. Some warped cylinder heads can be milled until the fireside surface is again flat. However, milling the surface reduces the thickness of the head, making the head more susceptible to future operating damage. Heads that can't be milled flat are typically scrapped.

One example of producing a casting having localized areas of improved thermal resistance of the cylinder head is U.S. Pat. No. 4,337,736 (the '736 patent) issued to Raush et al. The '736 patent discloses a cast iron cylinder head having a preformed workpiece of a thermal fatigue-resistant alloy material metallically bonded to the cylinder head around the valve bridge area to provide reinforcement in this area. The preformed workpiece has thin fusible sections, which melt when the hot base material is cast over them. Although the disclosure of the '736 patent may provide for localized areas of improved thermal resistance, it may be costly and have limited applicability.

The present disclosure is directed to overcoming one more of the problems set forth above.

### SUMMARY OF THE INVENTION

It is to be understood that both the foregoing general description and the following detailed description are exemplary and explanatory only and are not restrictive of the invention as claimed.

One aspect of the present disclosure is directed to a method of producing a component. The method may include form forming the component to include a void portion, heating the component to a first predetermined temperature, and adding a quantity of molten filler material into the void portion. The molten filler material may then further heat the void portion to chemically bond the filler material to the void portion.

Another aspect of the present disclosure is directed toward the component itself. The component may comprise a first component portion made from a first material and a second component portion made from a molten filler material. The first component portion may be produced with a void portion. The molten filler material may be cast into the void portion such that the second component portion is chemically bonded to the first component portion.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is an elevated view of a bottom surface of a cylinder head according to an embodiment of the present disclosure;

FIG. 1a is a sectional view of the cylinder head of FIG. 1 taken along line 1a-1a;

FIG. 2 is an elevated view of the bottom surface of a first component portion of the cylinder head of FIG. 1 according to an embodiment of the present disclosure;

FIG. 2a is sectional view of the first component portion of FIG. 2 taken along line 2a-2a;

FIG. 2b is a sectional view of the first component portion of FIG. 2 taken along line 2a-2a including a dam and plugs;

FIG. 2c is sectional view of the first component portion of FIG. 2 taken along line 2a-2a after the addition of a second component portion;

FIG. 2d is a sectional view of the first component portion of FIG. 2 taken along line 2a-2a after adding the second component portion and removing the dam and plugs; and

FIG. 3 is a flowchart describing a method of producing a component according to one embodiment of the present disclosure.

### DETAILED DESCRIPTION

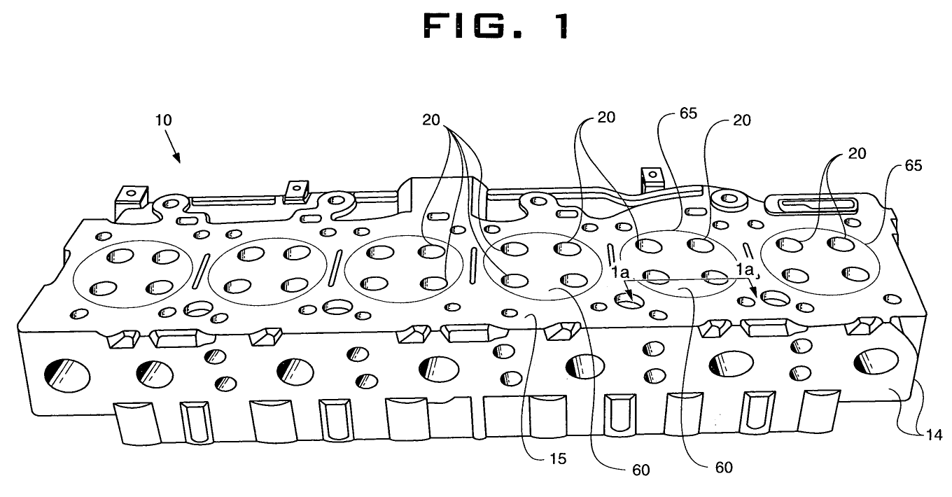

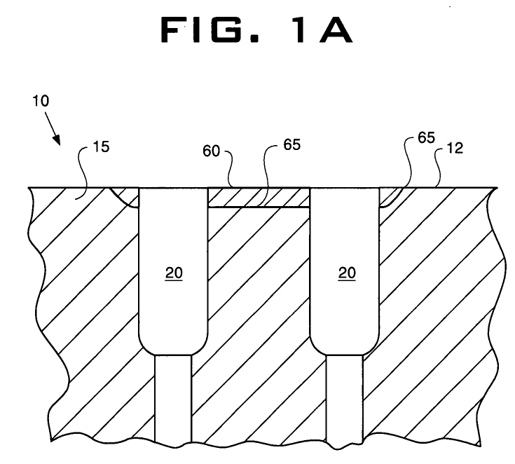

FIG. 1 is an elevated view of a bottom (fireside) surface 12 of a component, in this case a cylinder head 10, according to an embodiment of the present disclosure. The cylinder head 10 may include a first component portion 15 and a second component portion 60 separated by a bond layer 65. In this instance, the cylinder head 10 may be in a rough state after casting and some machining. The cylinder head 10 may include a plurality of side surfaces 14 in addition to the fireside surface 12 and a top surface (not shown). The fireside surface 12 may be cast with a plurality of valve openings 20 associated with each cylinder (not shown). The fireside surface 12 may be fastened to an engine block (not shown) after final machining the fireside surface 12, the valve openings 20, and other necessary openings, such as the fuel injector openings (not shown) associated with each cylinder (not shown).

FIG. 1a is a sectional view of the cylinder head 10 of FIG. 1 taken along line 1a-1a. The valve openings 20 are more clearly shown extending through the second component portion 60 and into the first component portion 15. A bond layer 65 is shown representing a metallurgical, or chemical, bond between the first component portion 15 and the second component portion 60. Although a gray iron cylinder head 10 is shown, it should be noted that the present disclosure is not limited to use with cylinder heads 10 cast from gray iron, but may be applied to other cast and non-cast components made from various other metallics, such as ductile iron, wrought steel, mild steel, stainless steel, aluminum and the like. While the second component portion 60 may also be gray iron, the second component portion 60 may be any one of a number of other materials, such as ductile iron, mild steel, stainless steel, inconel, aluminum and the like depending on compatibility with the first component portion 60. In the case where the base material of the first component portion 15 and the second component portion 60 is the same, the microstructure of the second component portion 60 may differ significantly from the first component portion 15, thereby imparting different physical properties.

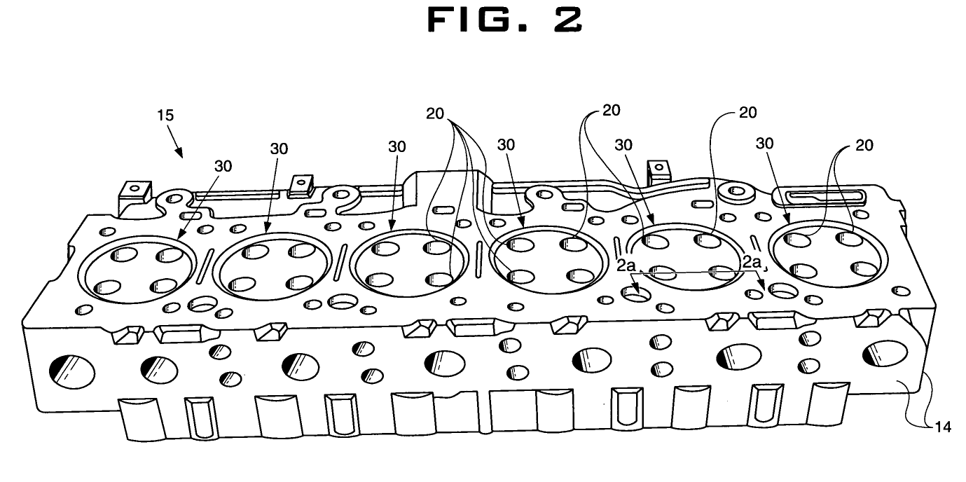

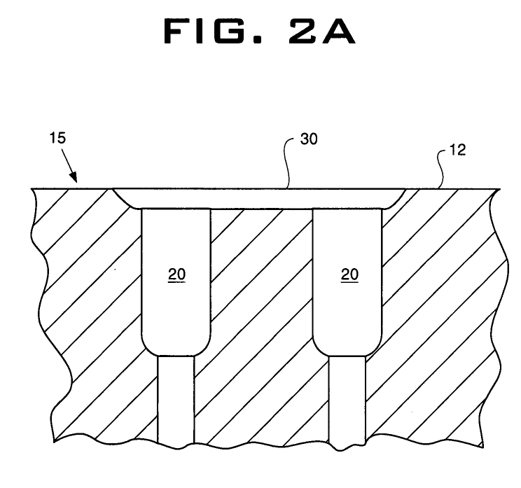

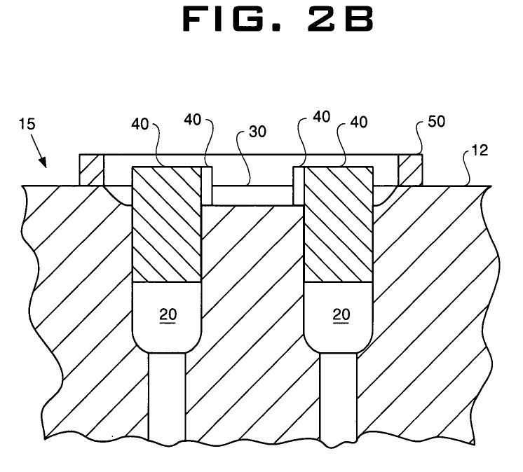

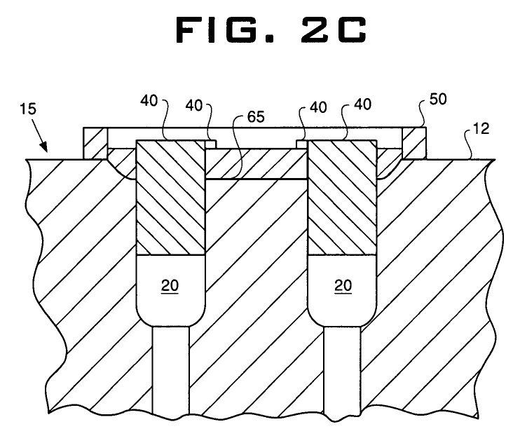

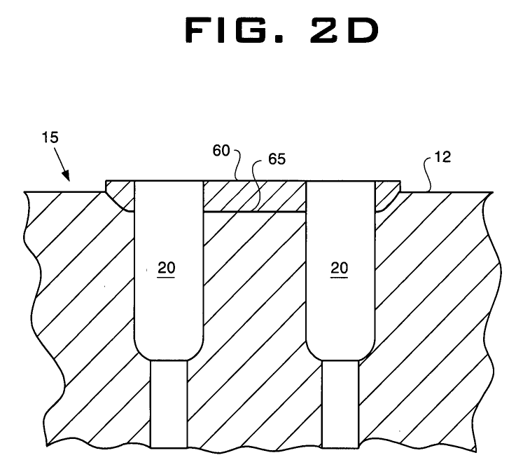

FIG. 2 is an elevated view of the bottom surface of a first component portion 15 of the cylinder head 10 according to an embodiment of the present disclosure. A plurality of void portions 30 may be shown produced in the first component portion 15. FIG. 2a is a sectional view of the first component portion 15 of FIG. 2 taken along line 2a-2a. The sectional view more clearly shows the void portion 30 and valve openings 20 cast into the cylinder head 10. The void portion 30 may be structured to receive a quantity of molten filler material to form the second component portion 60. As the molten filler material forms the second component portion 60, the terms may be interchanged throughout the disclosure and the figures.

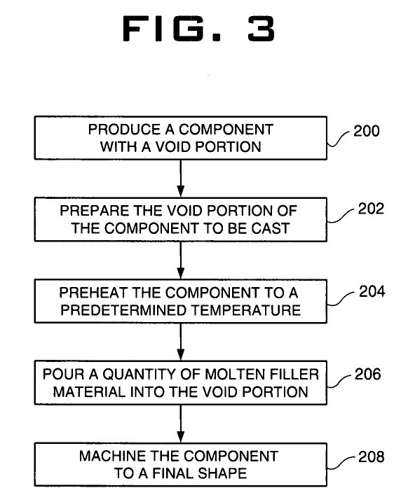

Referring now to FIG. 3, a flowchart is provided describing a method of producing a component 10 according to one embodiment of the present disclosure. In the first control block 200, the first component portion 15 of the component 10 may be produced with a void portion 30 in a predetermined area. This may be represented as shown in FIGS. 2 and 2a. Production of the first component portion 15 having at least one void portion 30 may be by any one of a number of operations, such as casting, forging, machining and the like. The void portion 30 may be created such that void portion 30, itself, may provide for an area to receive and contain the molten filler material 60 without a mold being necessary to the operation. In control block 202, the void portion 30 may be cleaned up as necessary to provide a surface suitable for forming a metallurgical bond upon the addition of a molted filler material 60. This may not always be required, but may include machining and the like to provide an oxide free surface in the void portion 30.

In the third control block 204, the component 10 may be preheated to a predetermined temperature. The preheat temperature will vary depending on the type and thickness of material surrounding the void portion 30 and the type and amount of molten filler material 60 being added to the void portion 30. For proper determination of preheat temperature, computer simulation or experimentation may be necessary. It may desirable to preheat the first component portion 15 as much as possible without damaging the component 10. Depending on the component 10, types of damage may include stress relieving and warping caused by overheating or melting of the original surface. On the other hand, failure to preheat the component 10 to high enough of a temperature may cause cracking of the parent material when the melted filler material is poured or lack of bonding between the two materials. In one embodiment, the preheat temperature for a cast iron cylinder head 10 may be in the range of 950° F. to 2000° F. For certain types of cylinder heads 10, a preheat temperature of 1100° F. has been found to reduce stress and warping while reducing the risk of cracking.

In the fourth control block 206, a quantity of filler material 60, or second component portion, is melted and poured into the void portion 30 of the first component portion 15. As the melting point of the first component portion 15 and the second component portion 60 may be the same or may be different, the melting point of the second component portion 60 may be exceeded to cause further heating of the first component portion 15 at the void portion 30. As the molten filler material 60, or second component portion, and the first component portions cool, a metallurgical bond may be formed between the filler material 60 and the first component portion 10 at a bond layer 65. In the final control block 208, the component 10, including the solidified filler material 60, may be machined to a final component shape.

### Industrial Applicability

Embodiments of the present disclosure may be applicable to produce a variety of components having localized areas of improved physical properties, such as improved thermal fatigue properties, hardness, and the like. Referring now to FIG. 2a, 2b, 2c and 2d, a method for casting a molten filler material 60 onto a solidified parent material prepared with a void portion 30 will be described in detail.

As shown in FIG. 2a, the first component portion 15 may be produced with a void portion 30 in a predetermined location to receive a molten filler material 60. The void portion 30 may be designed into the component 30 at a predetermined location in place of a portion of the component 30 where experience has shown similar components have failed or needed repair. Critical or crack prone areas identified through experience or finite element analysis may be typical areas to which the present disclosure may be applied. It is envisioned that the void portion 30 may be cleaned up as necessary to provide a surface suitable for forming a metallurgical bond upon the addition of a molted filler material 60.

FIG. 2b is a sectional view of the first component portion 15 of FIG. 2 taken along line 2a-2a including a dam 50 and plugs 40. Plugs 40 may prevent the molten filler material 60 from entering original features of the cylinder head 10. The plugs may be manufactured from a heat resistant material, such as machinable graphite and the like. In one embodiment the plugs may be capable of withstanding extreme temperatures without deforming and may be thermally conductive. The plugs 40 may not be necessary, but may also be of a variety of shapes and sizes to fill specific features. For example, a plug 40 to fill and protect a valve opening 20 is machined to a size and shape substantially equal to that of its respective rough valve opening 20. The plug 40 may be pushed into the valve opening 20, preventing filler material 60 from running through or otherwise filling the valve opening 20. Additionally a dam 50 may be positioned around the void portion 30 on the fireside surface 12. The dam 50 may be positioned on the fireside surface 12 in a manner where pouring the molten filler material 60 into the void portion 30 provides a riser of filler material 60. The dam 50 may be made of machinable graphite similar to the plug 40. The dam 50 may allow for a surplus of molten filler material 60 to be added to the void portion 30 to allow for shrinkage during cooling.

As described in the second control block 204, the cylinder head 10 may be preheated in an oven to a first temperature. In one embodiment the first temperature range is in the range of 950° F. to 2000° F., more preferably 1050° F. to 1150° F. From the preheat oven, the cylinder head 10, with the graphite plugs 40 and dams 50 in position, may be moved to a heated and insulated box (not shown) adapted to maintain the first temperature range and allow for addition of the molten filler material 60.

A quantity of filler material 60, such as cast iron, or other material suitable to attain the desired gradient properties in the void portion 30 is prepared by melting. For example, the filler material 60 may be melted in a crucible and held in a furnace at a temperature sufficient to complete a porosity free bond with the parent material. In the case of a cylinder head 10, the temperature may be approximately 2725° F. The filler material 60 may be of a chemical composition similar to that of the cylinder head 10 or component, or it could be quite different depending on the properties desired.

It is envisioned in the present disclosure that it may be necessary to locally heat the void portion 30 of the first component portion 15 to a second predetermined temperature. The second predetermined temperature may vary depending upon the type, mass and wall thickness of the parent material and the volume of filler material 60. The second predetermined temperature range is hot enough to permit bonding of the void portion 30 and filler material 60, but cool enough to prevent the filler material 60 from melting through the parent material of the void portion 30. The lower limit of the range may be determined through simulation and/or experimentation and may account for factors such as material shrinkage, bonding strength, microstructure, and stress associated the parent and/or filler material. Factors that impact bonding point may include type and volume of the parent material, the type and volume of the filler material, the chemistry of the parent component. Additionally, the second preheat temperature may prevent rapid cooling of the filler material 60, in turn maintaining desired mechanical properties. Additionally or alternatively, the molten filler material 60 may be heated beyond its melting point to further increase heating of the first component portion 15.

A quantity of welding flux (not shown) may also be applied to the void portion 30. The flux may act to remove oxidation, other contaminants, and aids in wetability of the filler material 60 onto the void portion 30 after the molten filler material 60 is poured. A typical flux may be manufactured from a borax-based material. With the temperature of the void portion 30 within second temperature range, molten filler material 60 may be removed from the furnace. Slag that may be floating on the surface of the molten filler material 60 may be skimmed from the melted filler material. With the molten filler material 60 substantially free of slag, it is poured into, and fills the void portion 30 as shown in FIG. 2c. In one embodiment, filler material may be permitted to overflow from the void portion 30 and rise above the bottom surface 12 along the dam 50.

After addition of the molten filler material 60, the component 10 may then be allowed to cool. In one embodiment, the component 10, or a portion thereof, may be partially cooled using compressed air. A wand (not shown) having a diffuser attached thereto and being attached to a compressed air source may be moved about, over the filler material 60. In one embodiment, to achieve desired mechanical properties, such as hardness and microstructure, it is desired to employ a cooling rate sufficient enough, depending on chemistry, to cool the entire volume of the void portion 30 to achieve desired microstructure, or transformation products, of the matrix structure at a newly formed bond layer 65 between the void portion 30 and the filler material 60. For example using cast iron and dependent on the volume of material affected, it may be desired to bring the temperature of the void portion 30 down to a range of 1100° F. to 1200° F. in a time period of 30 to 180 seconds. After all void portions 30 have been filled, the cylinder head 10 may be cooled, preferably, at a rate slow enough to avoid distortion or cracking of the component. The plugs 40 and dams 50 may then be removed as shown in FIG. 2d. The cylinder head 10 may then be machined to original specifications to form necessary valve seats (not shown) and fuel injector openings (not shown) such that the cylinder head 10 may be assembled for use.

What is claimed is:

1. A method of producing a component, comprising:
forming the component to include a void portion;
heating the component to a first predetermined temperature; and
adding a quantity of molten filler material into the void portion, the molten filler material further heating the void portion to chemically bond the filler material to the void portion.

2. The method of producing the component of claim 1, including the step of applying a flux to a surface of the component.

3. The method of producing the component of claim 1, wherein said first predetermined temperature is in a range of 950° F. to 1150° F.

4. The method of producing the component of claim 1, including the step of heating the void portion to a second predetermined temperature above the first predetermined temperature prior to adding the molten filler material.

5. The method of producing the component of claim 4, wherein said second predetermined temperature is in the range of 1650° F. to 1975° F.

6. The method of producing the component of claim 1, including the step of positioning a plug into a feature of the cast component, thereby preventing the flow of melted filler material into the feature.

7. The method of producing the component of claim 1, including the step of accelerating a cooling of said filler material.

8. The method of producing the component of claim 7, wherein said step of accelerating said cooling of said filler material includes using compressed air.

9. The method of producing the component of claim 1, wherein the component is a metal cast component.

10. The method of producing the component of claim 1, further comprising the step of final machining the component.

11. The method of producing the component of claim 1, including the step of providing a riser to accommodate shrinkage of the molten filler material.

12. The method of producing the component of claim 1, wherein the component is a cast iron component.

13. A component comprising:
a first component portion made from a first material, the first component portion produced with a void portion;
a second component portion made from a molten filler material cast into the void portion, the second component portion chemically bonded to the first component portion.

14. The component of claim 13, wherein the melting temperature of the second material is greater than the melting temperature of the first material.

15. The component of claim 13, wherein the first component portion has a volume greater than the volume of the second component portion.

16. The component of claim 13, wherein the first and second component portions are composed of gray iron, the second component portion having a microstructure having greater strength than the first component portion.

17. The component of claim 13, wherein the first component portion is gray iron and the second component portion is at least one of ductile iron, stainless steel, mild steel or inconel.

18. The component of claim 13, wherein the second component portion has a strength greater than the strength of the first component portion.

19. The component of claim 13, wherein the first component portion is composed of wrought iron.

20. The component of claim 13, wherein the second component portion has a hardness greater than the hardness of the first component portion.

21. The component of claim 13, wherein heating of the first component portion by the addition of the molten filler material enabled bonding between the first and second component portions.
